(19) United States
(12) Patent Application Publication
(10) Pub. No.: US 2010/0083509 A1
(43) Pub. Date: Apr. 8, 2010

(54) Folding scissors

(76) Inventors: Elizabeth A. Grist, Baltimore, MD (US); Ryan Singh, Loxahatchee, FL (US)

Correspondence Address: JOHN E. SIMMS JR., 8056 PHILADELPHIA ROAD, LOWER LEVEL, BALTIMORE, MD, 21237, US

(21) Appl. No.: 12/231,656

(22) Filed: Sep. 4, 2008

Related U.S. Application Data
(60) Provisional application No. 60/993,369, filed on Sep. 12, 2007.

(51) Int. Cl. B25G 1/00

(52) U.S. Cl. 30/341

(57) ABSTRACT

A pair of scissors which has ring portions foldable from a position 180° with respect to one another to a position where the ring portions are rotated between 90° each and are substantially parallel and adjacent with one another.

### CROSS REFERENCE TO RELATED APPLICATIONS

This application is related to provisional patent application Ser. No. 60/993,369 filed Sep. 12, 2007, the contents of which are incorporated by reference in their entirety.

### BACKGROUND OF THE INVENTION

1. Field of the Invention

The present invention relates to a pair of scissors which may be folded to a very compact form and which are easily unfolded for use.

2. Description of Related Art

Scissors have been used for many years and the problem of reducing the size of the scissors and making them more compact for storage, while allowing simple means to place the scissors in an operating condition has been addressed over the years. Further, means to provide for rotation of the finger loops have been addressed. U.S. Pat. No. 2,007,754 to Pichon discloses jointed links which can be folded to open and close the loops. Crawford in U.S. Pat. No. 2,952,912 discloses scissors handles that fold onto the scissor blades in the direction that the scissor opens and closes. The scissor handle hinges are parallel to the scissor blade hinge. A leaf spring presses the scissor handles to the inner wall portions of the scissor blade shafts. U.S. Pat. No. 3,906,630 to Megna discloses scissors with one stationary bow and one bow which can turn ±30° during use of the scissors. Chang in U.S. Pat. No. 5,781,999 teaches a thinning scissors with one finger ring to receive the user's ring finger. Moving the ring finger and the thumb relative to each other, the angular position of the finger ring is changed. Hirsch, in U.S. Pat. No. 6,370,991 discloses pliers with at least one grip pivotally connected with a neck section. A detent mechanism having a ball and spring hold the hand grip in first and second positions. In U.S. Patent Publication No. 2005/0005456 A1, Wang et al disclose a sensor having a ring body which is rotatable about the shaft of the blade by pulling the ring body away from the shaft and turning the ring body. The latter patents are directed primarily to use, not to storage of scissors.

### SUMMARY OF THE INVENTION

It is an object of the present invention to provide scissors which are easily folded to a compact form for storage which can simply be unfolded for use.

It is a further object to provide the foldable scissors which are inexpensive and easy to use.

In accordance with the teachings of the present invention, there is disclosed a scissors having a pair of members joined together at a pivot. Each of the members has a blade portion extending forwardly of the pivot. Each of the members further has a ring portion extending rearwardly of the pivot. Each of the ring portions is rotatably connected to the respective blade portion such that the ring portions are disposed in a normal operating position 180° from one another and each may be rotated through 90° towards one another. In this manner, the ring portions of the respective members are substantially coinciding for compactness or storage of the scissors.

In further accordance with the teachings of the present invention, there is disclosed a scissors having a pair of members joined together at a pivot. Each of the members has a blade portion extending forwardly of the pivot. Each of the members has an end rearwardly of the pivot. The ends are in the form of a cylindrical shaft. A groove is formed in each cylindrical shaft, the groove extending through 90°. A pair of ring portions are provided. Each ring portion has a cylindrical bore formed in a thickness of the ring portion. The cylindrical shaft of the respective members are received in the cylindrical bore in the respective ring portions, wherein the ring portions may rotate about the cylindrical shafts. Each ring portion further has an opening formed in a flat surface of the ring portion. A pin is disposed in each opening in the respective ring portion. The respective pins engage the respective grooves in the cylindrical shafts, thereby retaining the respective ring portions on the respective members such that the ring portions may rotate 90° in opposite directions to be coinciding in a storage position or to be 180° apart in an operating position.

These and other objects of the present invention will become apparent from a reading of the following specification taken in conjunction with the enclosed drawings.

### BRIEF DESCRIPTION OF THE DRAWINGS

FIG. 1 is a perspective view of the assembled scissors in a use configuration.

FIG. 2 is a perspective view showing the scissors transitioning between a use configuration and a storage configuration.

FIG. 3 is a perspective view of the assembled scissors in a storage configuration.

FIG. 4 is a perspective view of one arm of the scissors.

FIG. 5 is a top plan view of one arm of the scissors.

FIG. 6 is a side elevation view of one arm of the scissors.

FIG. 7 is a cross-sectional view taken across lines 7-7 of FIG. 5.

FIG. 8 is a perspective view of the other arm of the scissors.

FIG. 9 is a top plan view of the other arm of the scissors.

FIG. 10 is a side elevation view of the other arm of the scissors.

FIG. 11 is a cross-sectional view taken across the lines 11-11 of FIG. 9.

FIG. 12 is a top plan view of the ring portion.

FIG. 13 is a side elevation view of a ring portion.

FIG. 14 is a cross-sectional view taken across the lines 14-14 of FIG. 13.

FIG. 15 is an exploded view of the scissors.

FIG. 16 is an exploded view of the scissors having a rounded tip.

FIG. 17 is a cross-sectional view taken across the lines 17-17 of FIG. 1.

### DESCRIPTION OF THE PREFERRED EMBODIMENTS

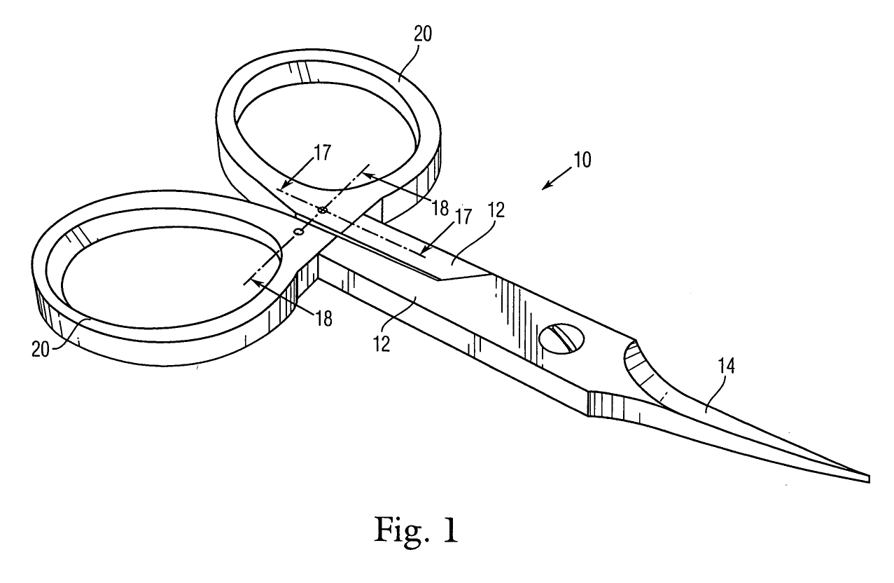

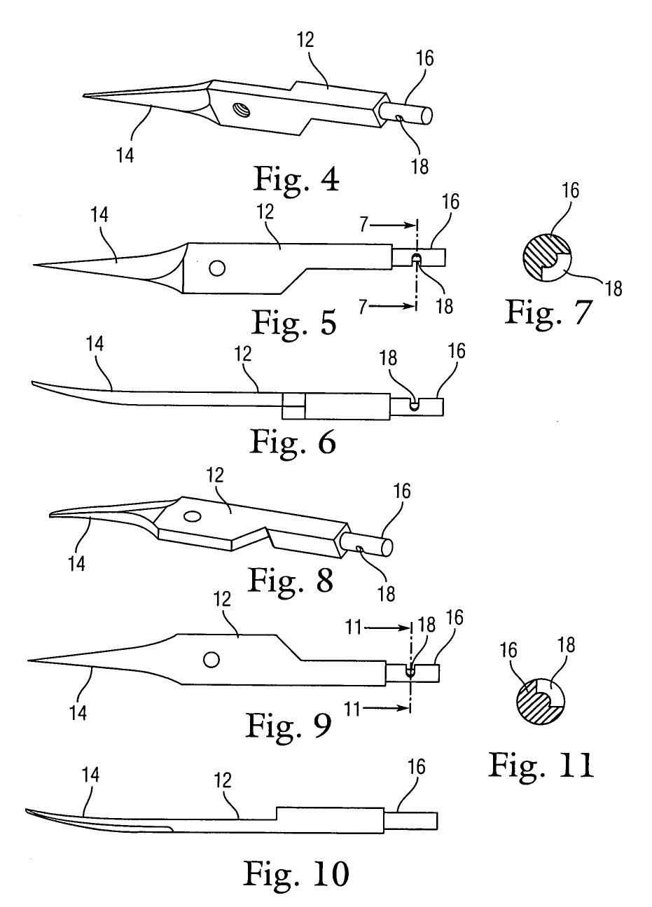

Referring now to FIGS. 1-10, the scissors 10 has a pair of arms 12, each arm having a side with a blade edge 14. The arms are pivotally mounted about a single center piece such that the blade edges 14 oppose one another and serve as the cutting means for the scissors 10. At the base of each arm, there is an extending cylindrical shaft 16 with a groove 18 which is formed through 90° of the shaft 16.

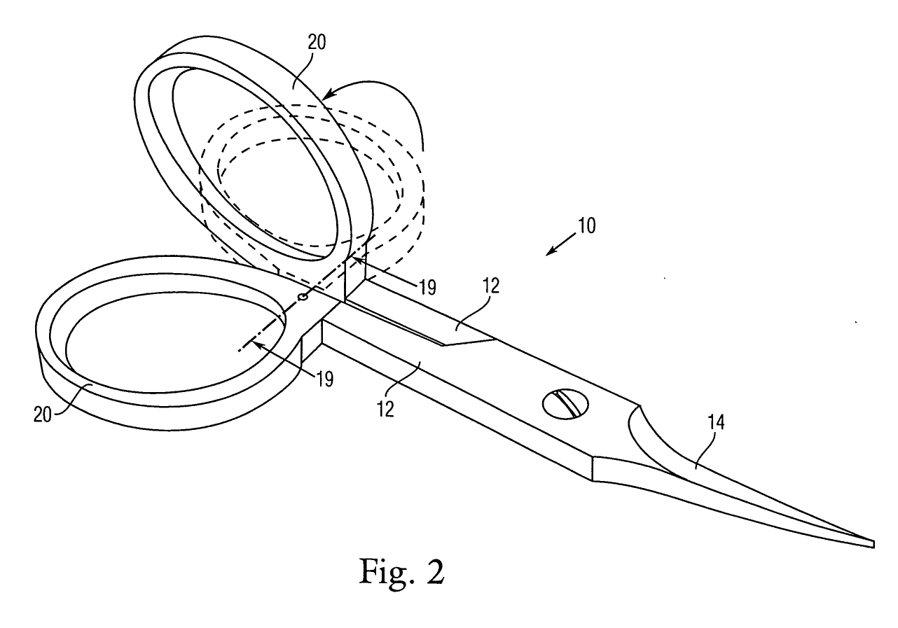

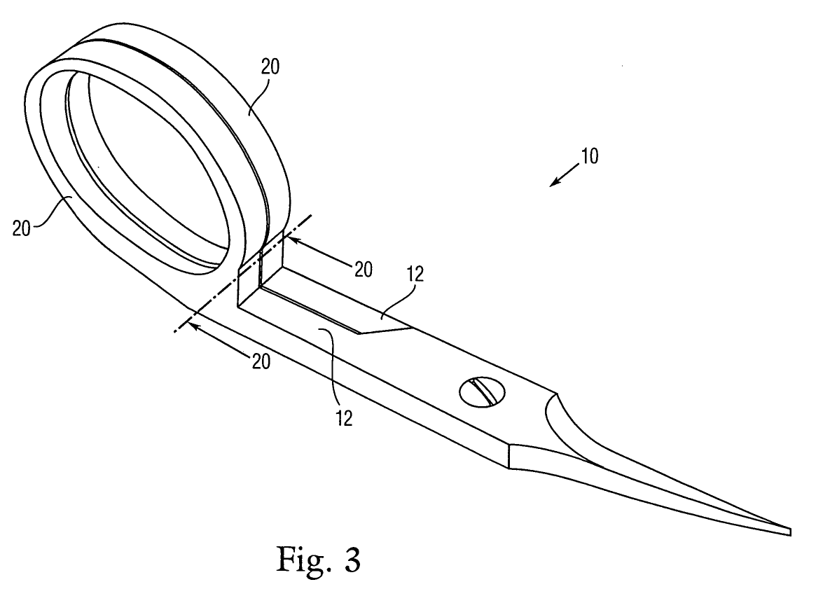

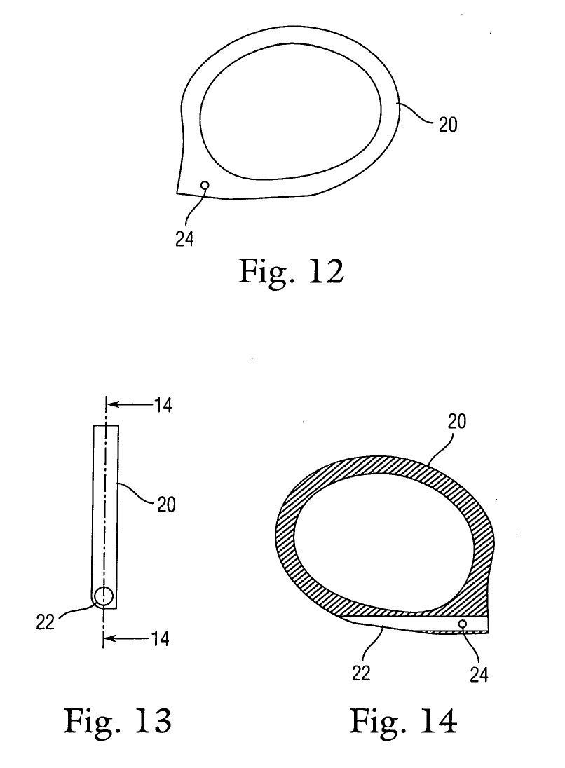

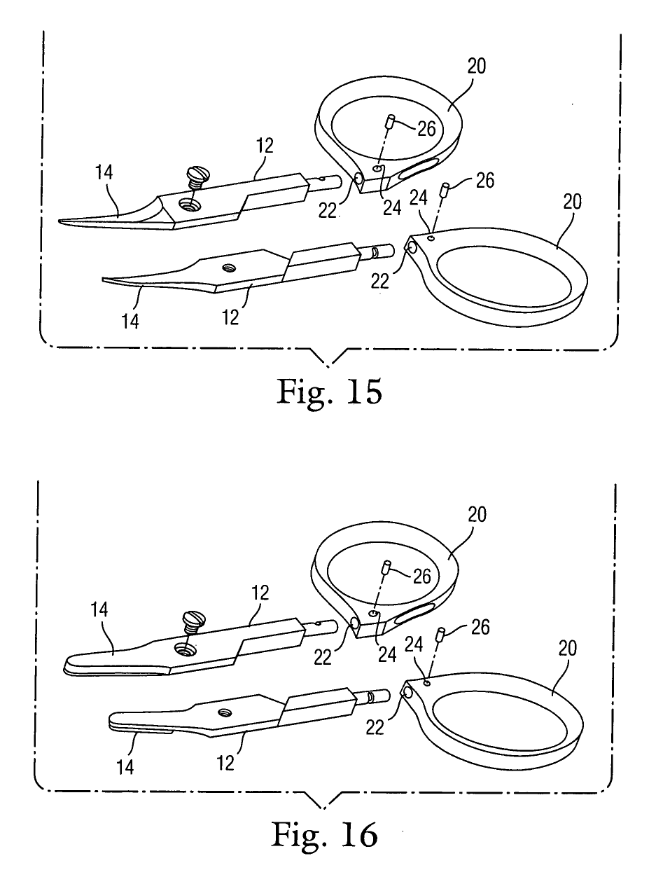

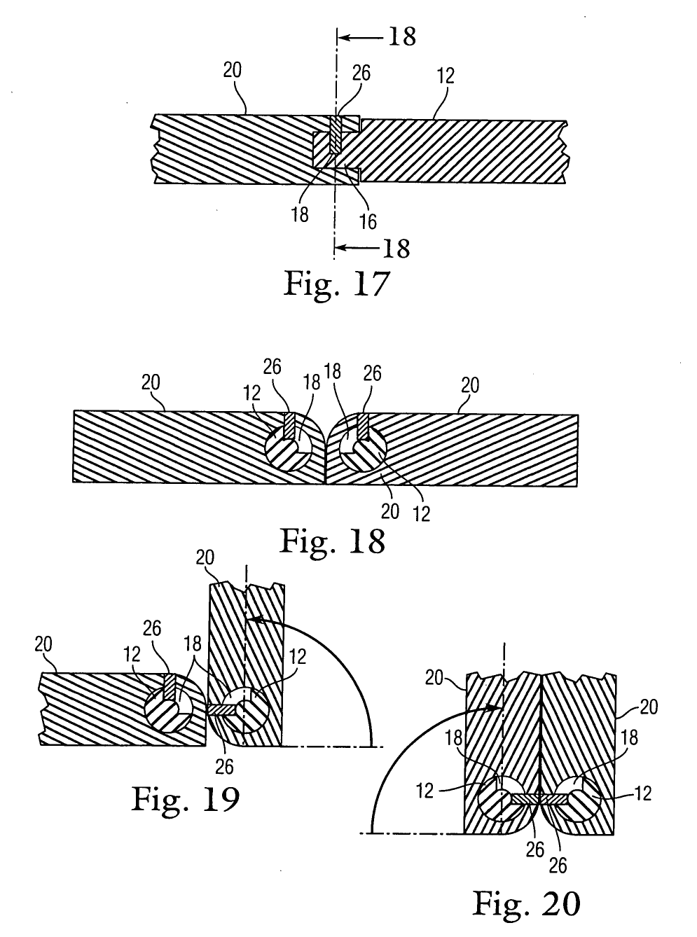

As seen in FIGS. 12-16, a pair of ring portions 20 serve as the finger receptacles on the scissors 10. Each ring portion 20 has a first cylindrical bore 22 formed in a thickness of the ring. The cylindrical shaft 16 of the respective arms is received in the bores 22 in the rings 20. In this manner, the rings 20 may be rotated around the cylindrical shafts 16. The rings 20 may rotate from a position where the rings 20 may be parallel and adjacent to one another (FIG. 3) through an intermediate portion (FIG. 2) to a position where the rings 20 are 180° apart with respect to one another and form a standard operating scissor configuration (FIG. 1). Each ring portion 20 further has an opening 24 formed in the flat surface of the ring, the opening 24 communicating with the cylindrical bore 22 in the thickness of the ring 20. A pin 26 is disposed in the opening 24 such that the pin 26 engages the groove 18 formed through 90° of the shaft 16 on the base of the respective arm 12. The pin 26 retains the ring portion 20 on the arm 12 and permits the ring 20 to rotate through 90° (FIG. 17). The 90° rotation of each ring portion 20 in opposite directions results in the ring portions 20 being 180° apart from one another (FIG. 1). As shown in FIG. 2, the scissors are in transition with one ring being rotated through 90° and the other ring being rotated through 180°.

The arms 16 may be formed with a pointed tip 28 or a rounded tip 30 (FIG. 16) opposite from the cylindrical shaft 16 to which the ring portions 20 are attached. Removal of the ring portions 20 from the arms 12 permits the scissors 10 to be assembled with pointed tips 28 or round tips 30.

Obviously, many modifications may be made without departing from the basic spirit of the present invention. Accordingly, it will be appreciated by those skilled in the art that within the scope of the appended claims, the invention may be practiced other than has been specifically described herein.

What is claimed is:

1. In a scissors having a pair of members joined together at a pivot, each of the members having a blade portion extending forwardly of the pivot, and each of the members further having a ring portion extending rearwardly of the pivot, the improvement wherein each of the ring portions is rotatably connected to the respective blade portion such that the ring portions are disposed in a normal operating position 180° from one another and each may be rotated through 90° toward one another wherein the ring portions of the respective members are substantially coinciding for compactness of storage of the scissors.

2. The scissors of claim 1, wherein the blade portion has a pointed tip opposite from the ring portion.

3. The scissors of claim 1, wherein the blade portion has a rounded tip opposite from the ring portion.

4. The scissors of claim 1, wherein the scissors has interchangeable members, the members having a pointed tip or a rounded tip.

5. The scissors of claim 1, wherein each member has an end rearwardly of the pivot, the ends being in the form of a cylindrical shaft, a groove being formed in each cylindrical shaft, the groove extending through 90°,
each ring portion having a cylindrical bore formed in a thickness of the ring portion,
the cylindrical shaft of the respective members being received in the cylindrical bore in the respective ring portions, wherein the ring portions may rotate about the cylindrical shafts,
each ring portion further having an opening formed in a flat surface of the ring portion, a pin disposed in each opening in the respective ring portion, the respective pins engaging the respective grooves in the cylindrical shafts, thereby retaining the respective ring portions on the respective members such that the ring portions may rotate 90° in opposite directions to be coinciding in the storage position or to be 180° apart in the operation position.

6. A scissors having a pair of members joined together at a pivot, each of the members having a blade portion extending forwardly of the pivot, and each of the members having an end rearwardly of the pivot, the ends being in the form of a cylindrical shaft, a groove being formed in each cylindrical shaft, the groove extending through 90°,
a pair of ring portions,
each ring portion having a cylindrical bore formed in a thickness of the ring portion,
the cylindrical shaft of the respective members being received in the cylindrical bore in the respective ring portions, wherein the ring portions may rotate about the cylindrical shafts,
each ring portion further having an opening formed in a flat surface of the ring portion, a pin disposed in each opening in the respective ring portion, the respective pins engaging the respective grooves in the cylindrical shafts, thereby retaining the respective ring portions on the respective members such that the ring portions may rotate 90° in opposite directions to be coinciding in a storage position or to be 180° apart in an operating position.

7. The scissors of claim 5, wherein each blade portion has a pointed tip opposite from the ring portion.

8. The scissors of claim 5, wherein each blade portion has a rounded tip opposite from the ring portion.

9. The scissors of claim 5, wherein the scissors has interchangeable members, the members having a pointed tip or a rounded tip.
